(19) United States
(12) Patent Application Publication
(10) Pub. No.: US 2015/0207269 A1
(43) Pub. Date: Jul. 23, 2015

(54) CARD CONNECTOR WITH METALLIC RETAINING PLATE

(71) Applicant: FOXCONN INTERCONNECT TECHNOLOGY LIMITED, Grand Cayman (KY)

(72) Inventors: LU-LU SHA, Kunshan (CN); DING-BING FAN, Kunshan (CN); JI-CHAO WANG, Kunshan (CN); GUO-HUA ZHANG, Kunshan (CN); QI-SHENG ZHENG, Kunshan (CN)

(21) Appl. No.: 14/604,652

(22) Filed: Jan. 23, 2015

(30) Foreign Application Priority Data
Jan. 23, 2014 (CN) 201420042534.6

(51) Int. Cl. H01R 13/627; H01R 12/71

(52) U.S. Cl. CPC H01R 13/6272; H01R 12/716

(57) ABSTRACT

A card connector includes an insulating housing, a plurality of conductive terminals and a retaining plate. The insulating housing has a base portion, an upper face, a lower face, a mating frame with a mating cavity which has a mating face parallel to the lower face. The conductive terminals have contacting portions extending into the mating cavity. The base portion has a retaining space recessed upwardly from the lower face and a platform located at the upper face of the base portion, and the retaining space upwardly runs through the platform. A stopping portion is formed between the retaining space and the mating frame. The retaining plate is retained in the retaining space and has a plurality of soldering legs extending downwardly out of the lower face and a latch portion extending upwardly and latching with the stopping portion.

### BACKGROUND OF THE INVENTION

1. Field of the Invention

The present invention generally relates to a card connector, and more particularly to a card connector provided with a metallic retaining plate.

2. Description of Related Art

Chinese patent No. 201252181 discloses a card connector having a mounting plane mounted on a printed circuit board and a mating plane mated with a complementary electronic card and being perpendicular to the mounting plane. In use, the complementary connector is inserted into a mating cavity of the card connector in a direction parallel to the mounting plane. Nowadays, to meet requirement of different users, a vertical card connector which is different from the card connector aforementioned is provided. The difference between them is that the vertical card connector has a mounting surface parallel to a mating surface. As we all know, the card connector is becoming smaller and smaller, if the vertical card connector is fabricated as a tabular type body, the vertical card connector is easily pulled down from the printed circuit board by a force in a horizontal direction. Even though some simple metallic retaining plates are provided to a housing of the vertical card connector, the retaining plates and the housing still may be separated from each other by a large force from external, consequently the vertical card connector is pulled down from the printed circuit board.

In view of the foregoing, a card connector with a metallic retaining plate is able to overcome the drawbacks described aforementioned would be desirable.

### SUMMARY OF THE INVENTION

Accordingly, an object of the present invention is to provide a card connector, the card connector has a metallic retaining plate secured therein.

In order to achieve the object set forth, a card connector is provided with an insulating housing, a plurality of conductive terminals secured in the insulating housing and a retaining plate retained in the insulating housing. The insulating housing has a base portion, an upper face atop the base portion, a lower face on a bottom of the base portion, a mating frame extending upwardly from the upper face of the base portion, a mating cavity formed in the mating frame and a mating face atop the mating frame and parallel to the lower face. The conductive terminals have contacting portions extending into the mating cavity along a vertical direction perpendicular to the mating face. The base portion has a retaining space recessed upwardly from the lower face and a platform located at the upper face of the base portion, the retaining space upwardly runs through the platform, a stopping portion is formed between the retaining space and the mating frame, the retaining plate is retained in the retaining space and has a plurality of soldering legs extending downwardly out of the lower face and a latch portion extending upwardly and latching with the stopping portion.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a card connector mounted on a printed circuit board of the present invention;

FIG. 2 is another perspective view of the card connector in FIG. 1;

FIG. 3 is an exploded perspective view of the card connector in FIG. 1;

FIG. 4 is another exploded perspective view of the card connector in FIG. 1; and

FIG. 5 is a sectional perspective view along line 5-5 of the card connector mounted on the printed circuit board in FIG. 1.

### DETAILED DESCRIPTION OF THE INVENTION

Reference will now be made in detail to the preferred embodiment of the present invention.

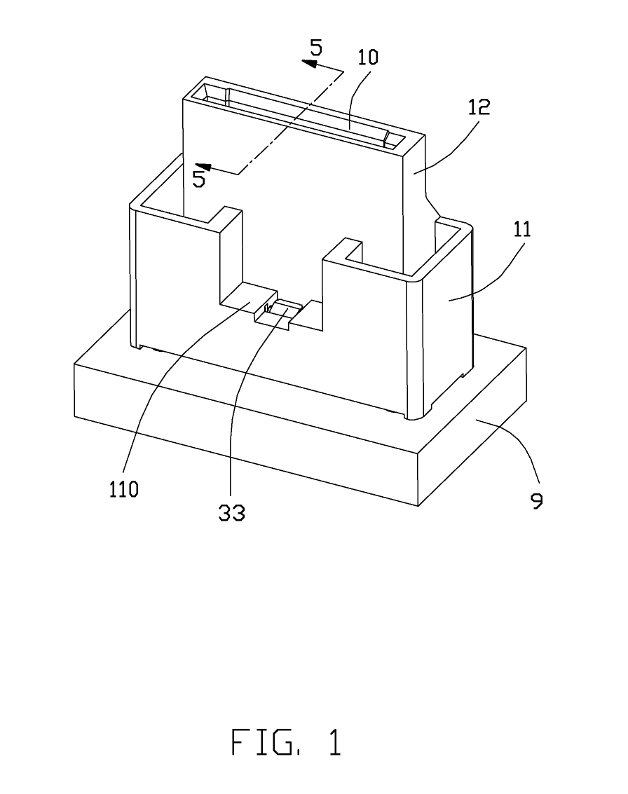

FIG. 1 to FIG. 3 are taken to describe a vertical card connector 100 provided with an insulating housing 1, a plurality of conductive terminals 2 secured in the insulating housing 1 and a retaining plate 3 retained to the insulating housing so as to fix the card connector 100 onto a printed circuit board 9. The retaining plate 3 is made of a metallic plate in present invention.

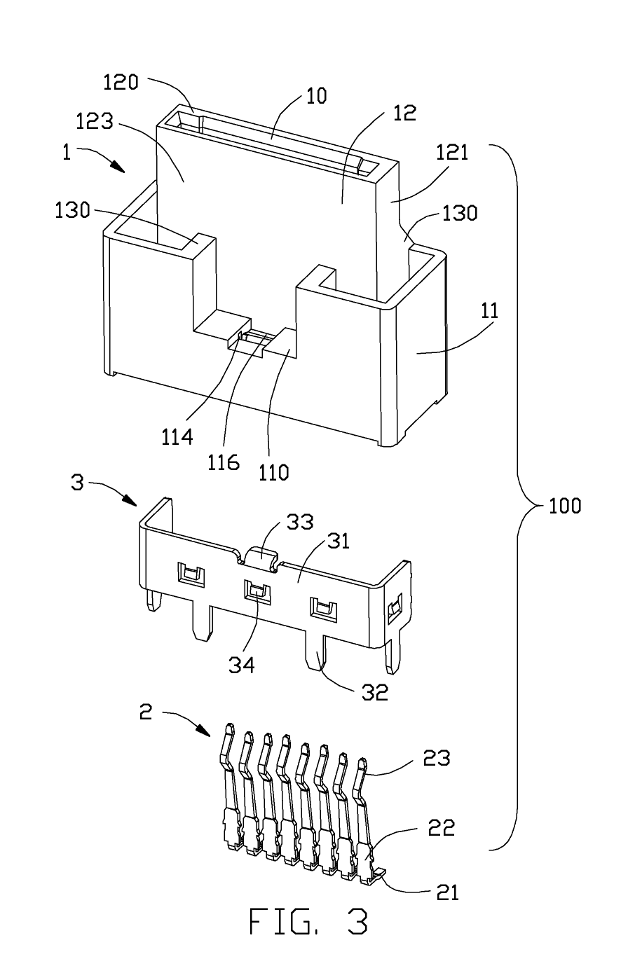

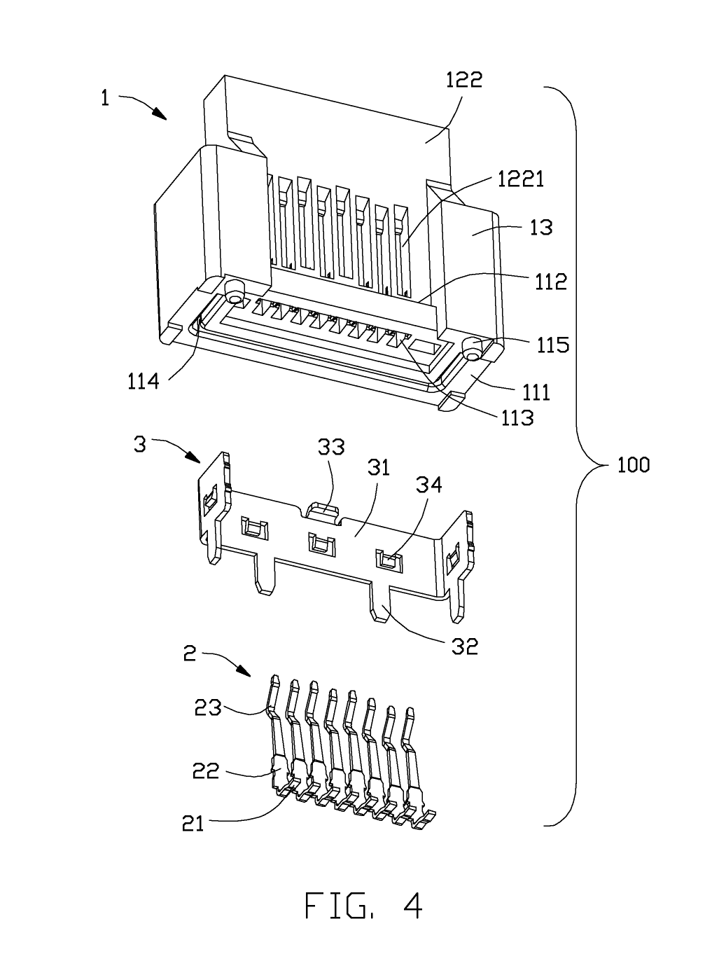

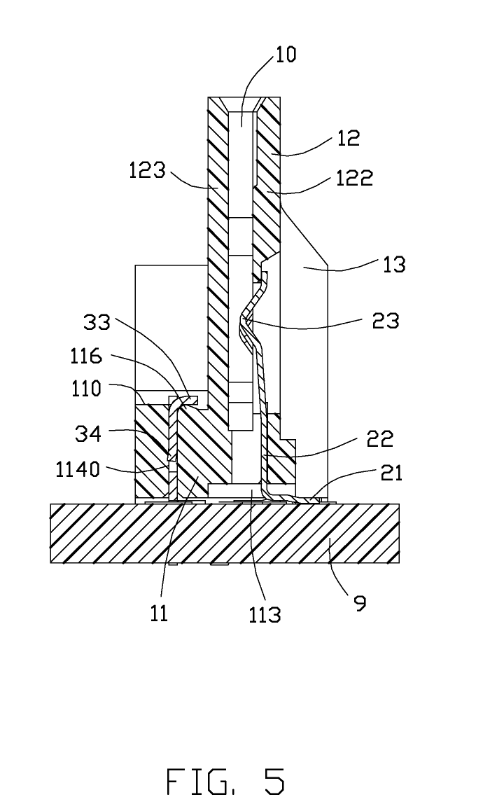

Referring to FIG. 3 and FIG. 4, the insulating housing 1 has a base portion 11 mounted on the printed circuit board 9, a flat mating frame 12 extending upwardly from a top of the base portion 11 and a mating cavity or card receiving slot 10 recessed inwardly from the top face of the mating frame 12. Combined to FIG. 5, the base portion 11 has a lower face 111 located below the base portion 11 and an upper face 112 located atop the base portion 11. The mating frame 12 has a mating face 120 located atop thereof and parallel to the lower face 111. The mating frame 12 comprises two narrow side walls 121 and opposite a front wall 122 and a rear wall 123 connecting with the two side walls 121, and all of them together surround the mating cavity 10. Said mating cavity 10 is recessed downwardly from the mating face 120 to the upper face 112 of the base portion 11. Said base portion 11 defines a plurality of fixing holes 113 running downwardly through the lower face 111 thereof, a retaining space 114 appeared as “U” shaped recessed upwardly from the lower face 111 thereof and two mounting posts 115 protruding downwardly from the lower face thereof and disposed at two corners thereof The fixing holes 113 are disposed in one row between the two mounting posts 115 for fixing the conductive terminals 2. The front wall 122 defines a plurality of receiving grooves 1221 running through the front-to-rear face thereof and communicating with the mating cavity 10 and the fixing holes 113. The insulating housing 1 defines a protecting wall 13 extending upwardly from peripheral area of the base portion 11 and surrounding the two side walls 121 and part of the front and the rear walls 122, 123 so as to enhance the stability of the vertical card connector 100 in using and mounting process. The protecting wall 13 itself is not continuous, and four connecting walls 130 are provided to connect the protecting wall 13 with the front and rear walls 122, 123, thereby dividing the protecting wall 13 into two parts. The connecting walls 130 connect with two side edges of the front wall 122 and two side areas of the rear wall 123. The base portion 11 defines a platform 110 protruding upwardly from the upper face 122 thereof and between the two connecting walls 130 which connect the protecting wall 13 with the rear wall 123. Said retaining space 114 runs upwardly through the middle area of the platform 110. Combined to FIG. 5, a stopping portion 116 is formed on the platform 110 and is located between the retaining space 114 and the rear wall 123 of the mating frame 12.

Referring to FIG. 4, each conductive terminal 2 comprises a retaining section 22 retained in the fixing hole 113, an elastic contacting section 23 extending upwardly along a direction perpendicular to the mating face 120 from one end of the retaining section 22 and a soldering section 21 extending downwardly initially and then outwardly and horizontally from the other end of the retaining section 22. The soldering sections 21 are soldered onto an upper surface of printed circuit board 9 horizontally, and the contacting sections 23 are received in the receiving grooves 1221 and partly protrude into the mating cavity 10 so as to electrically connect with the complementary electronic card (not show).

The retaining plate 3 has a main body 31 configured as a “U” shaped and secured in the retaining space 114 and a plurality of soldering legs 32 extending downwardly from a lower side of the main body 31. The main body 31 is shown as schistose structure and extends along an upper-to-down direction. The retaining plate 3 defines a latch portion 33 in the middle area of an upper edge of the main body 31 which corresponds to the stopping portion 116. A plurality of barbs 34 are tore from a middle area of the main body 31. When the retaining plate 3 is assembled into the retaining space 114, the latch portion 33 initially runs upwardly through the retaining space 114 and protrudes out of the platform 110, and then is bent inwardly and downwardly to latch the stopping portion 116. Combined to FIG. 5, the barbs 34 interferes with an inner wall 1140 of the retaining space 114 so as to enhance the fixation between the retaining plate 3 and the insulating housing 1. Finally, the retaining plate 3 is firmly retained in the retaining space 114.

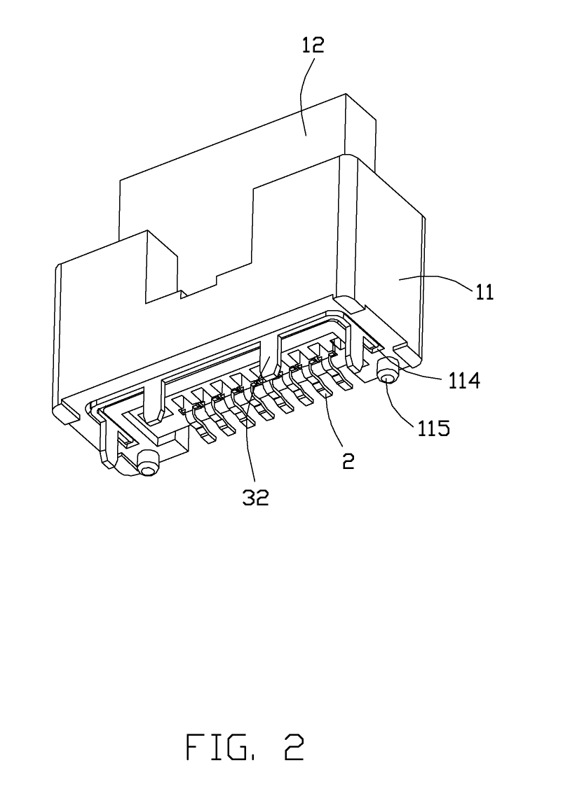

Referring to FIG. 1 and FIG. 2, the card connector 100 is mounted on the printed circuit board 9. The soldering sections 21 of the conductive terminals 2 are arranged in one row at a side of the lower face 111 along a longitudinal direction and soldered onto the printed circuit board 9 horizontally. Some soldering legs 32 of the retaining plate 3 are arranged in one row at the other side of the lower face 111 opposite to the soldering sections 21 along a longitudinal direction, some other soldering legs 32 are disposed at the rest two sides of the lower face 111, which are combined with the soldering sections 21 to fix the vertical card connector 100 onto the printed circuit board 9. The latch portion 33 of the retaining plate 3 and the stopping portion 116 of the insulating housing 1 are latched with each other, the soldering legs 32 are soldered onto the printed circuit board 9. With these fixing features, the insulating housing 1 is hard to separate from the retaining plate 3 even though a force comes from a horizontal direction. That is to say, the fixation between the card connector 100 and the printed circuit board 9 is stability.

It is to be understood, however, that even though numerous characteristics and advantages of the present invention have been set forth in the foregoing description, together with details of the structure and function of the invention, the disclosure is illustrated only, and changes may be made in detail, especially in matters of shape, size, and arrangement of parts within the principles of the invention to the full extent indicated by the broad general meaning of the terms in which the appended claims are expressed.

We claim:

1. A card connector comprising:
an insulating housing having a base portion, an upper face atop the base portion, a lower face on a bottom of the base portion, a mating frame extending upwardly from the upper face of the base portion, a mating cavity formed in the mating frame and a mating face atop the mating frame and parallel to the lower face;
a plurality of conductive terminals secured in the insulating housing and having contacting portions extending into the mating cavity along a vertical direction perpendicular to the mating face; and
a retaining plate retained in the insulating housing;
wherein the base portion has a retaining space recessed upwardly from the lower face and a platform located at an upper face of the base portion, the retaining space upwardly runs through the platform, a stopping portion is formed between the retaining space and the mating frame, the retaining plate is retained in the retaining space and has a plurality of soldering legs extending downwardly out of the lower face and a latch portion extending upwardly and latching with the stopping portion.

2. The card connector as claimed in claim 1, wherein the retaining plate has a main body received in the retaining space, and the latch portion is formed in the middle of an upper side edge of the main body.

3. The card connector as claimed in claim 2, wherein the retaining space is configured as “U” shaped, the main body of the retaining plate is shown as a schistose structure which extends along an upper-to-down direction and upwardly assembles into the retaining space from the lower face.

4. The card connector as claimed in claim 3, wherein the main body of the retaining plate has a plurality of barbs tore from a middle area thereof, and the barbs are interfered with inner surfaces of the retaining space.

5. The card connector as claimed in claim 2, wherein the latch portion of the retaining plate is bent inwardly to the mating frame in order to downwardly latch with the stopping portion.

6. The card connector as claimed in claim 1, wherein the conductive terminals have retaining sections extending downwardly from the contacting portions and retained in the base portion and soldering sections extending initially downwardly and then outwardly along a horizontal direction from the retaining sections, the soldering sections are arranged in one row at a side of the lower face of the base portion, and the soldering legs are arranged in one row at the other side of the lower face of the base portion opposite to the soldering sections.

7. The card connector as claimed in claim 6, wherein the base portion has a plurality of fixing holes downwardly running through the lower face thereof and communicating with the mating cavity, and the retaining sections of the conductive terminals are retained in the fixing holes.

8. The card connector as claimed in claim 1, wherein the mating frame has two narrow side walls and opposite front wall and rear wall connecting with the two side walls, all of them together surround the mating cavity, the front wall defines a plurality of receiving grooves communicating with the mating cavity, the contacting portions of the conductive terminals are received in the receiving grooves and partly protrude into the mating cavity.

9. The card connector as claimed in claim 8, wherein the insulating housing has a protecting wall extending upwardly from a peripheral area of the base portion and surrounds the mating frame.

10. The card connector as claimed in claim 1, wherein the base portion defines a pair of mounting posts extending downwardly from the lower face thereof and located in two corners at a side of the lower face opposite to the soldering legs of the retaining plate.

11. A card connector mounted on a printed circuit board, comprising:
an insulating housing having two side walls and opposite a front wall and a rear wall connecting with the two side walls, the four walls surrounding to form a mating frame with a mating cavity upwardly opening, the insulating housing further having a base portion surrounding the mating frame;
a plurality of conductive terminals retained in the front wall and partly protruding into the mating cavity, the conductive terminals having soldering sections extending downwardly initially and then outwardly along a horizontal direction opposite to the rear wall; and
a fixing shell fixed in the base portion at a side facing to the rear wall;
wherein the base portion has a first stopping portion on a top thereof, and the fixing shell has a second stopping portion downwardly attached to the first stopping portion and a plurality of soldering legs extending downwardly out of the base portion combined with the soldering sections to be soldered to the printed circuit board.

12. The card connector as claimed in claim 11, wherein the base portion has a retaining slot running through the base portion along a top to bottom direction, the fixing shell has a plurality of barbs tore therefrom and interfered with inners surface of the retaining slot.

13. The card connector as claimed in claim 11, wherein the fixing shell has a flat main body and two side portions extending forwardly from left and right side of the main body, the second stopping portion is bent inwardly or outwardly from the top side of the main body, some soldering legs extending downwardly from the main body, and the others extending downwardly from the two side portions.

14. A card connector assembly comprising:
a printed circuit board
an insulative housing with a bottom side mounted upon the printed circuit board and forming a card receiving slot upwardly communicating with an exterior in a vertical direction and extending along a longitudinal direction perpendicular to said vertical direction;
a plurality of contacts disposed in the housing and located by one longitudinal side of the card receiving slot in a transverse direction perpendicular to both said vertical direction and said longitudinal direction;
a metallic retaining plate attached to the housing and defining a U-shaped configuration in a top view to surround the other longitudinal side and two opposite transverse sides of the card receiving slot;
a retaining space formed in the housing and defining a U-shaped configuration in a bottom view to receive said retaining plate therein; wherein
said retaining plate forms a plurality of soldering legs extending downwardly beyond the bottom side of the housing.

15. The electrical connector assembly as claimed in claim 14, wherein the housing includes a pair of mounting posts located adjacent to two opposite ends of the U-shaped retaining space and essentially by said one longitudinal side of the card receiving slot, and extending downwardly beyond the bottom side of the housing for mounting to the printed circuit board.

16. The electrical connector assembly as claimed in claim 14, wherein said retaining space is configured to allow the retaining plate to be assembled thereinto upwardly from a the bottom side of the housing.

17. The electrical connector assembly as claimed in claim 14, wherein the housing forms a plurality of fixing holes by said one longitudinal side of the card receiving slot to receive the corresponding contacts therein, and said fixing holes communicate with an exterior in the transverse direction.

18. The electrical connector assembly as claimed in claim 14, wherein the housing includes a mating frame in which said card receiving slot is formed, a protecting wall surrounding said U-shaped retaining space and said mating frame, and said protecting wall forms a cutout so as to easily bend a latch portion of the retaining plate, said protecting wall being higher than the retaining plate.

19. The electrical connector assembly as claimed in claim 18, wherein said housing includes a pair of connecting walls extending in the transverse direction to connect the protecting wall and the mating frame.

20. The electrical connector assembly as claimed in claim 18, wherein a top face of the mating frame is higher than the protecting wall, and the protecting wall has a height twice of said retaining plate.
